(19) United States
(12) Patent Application Publication
(10) Pub. No.: US 2007/0295158 A1
(43) Pub. Date: Dec. 27, 2007

(54) Drive axle assembly housing breather

(76) Inventors: Jacob Adleman, Grand Ledge, MI (US); Steven T. Byrne, Portage, MI (US); Michael F. Miller, Portage, MI (US); Mark A. Schneider, Pewamo, MI (US)

Correspondence Address: MARSHALL & MELHORN, FOUR SEAGATE, EIGHT FLOOR, TOLEDO, OH, 43604, US

(21) Appl. No.: 11/437,241

(22) Filed: May 19, 2006

(51) Int. Cl. F16H 57/02; F16H 61/00

(52) U.S. Cl. 74/606 R

(57) ABSTRACT

A device for communicating fluid into and out of a vehicle drive axle assembly housing is disclosed. The device has an elbow that connects with a body portion. The elbow has a baffle and the body portion has more than one baffle. The baffles prevent fluid in the drive axle housing from escaping from the housing.

### FIELD OF THE INVENTION

The present invention relates to a breather for a drive axle assembly housing of a vehicle.

### BACKGROUND OF THE INVENTION

Breathers for vehicle drive axle assemblies are well-known devices for preventing vacuum or pressure build-up in the drive axle assembly housing of a vehicle. Breathers are also well-known for minimizing the amount of moisture that may enter the assembly housing from the outside and for reducing to amount of lubricant that may escape from the axle assembly housing.

The prior art breathers, however, suffer from several disadvantages. For example, many known prior art breathers leak lubricant, regardless of their location or their construction. Some prior art devices have become more complex in an attempt to effectively keep lubricant in, let pressure out and prevent moisture from entering the axle housing, however, this complexity has made many breathers costly.

Furthermore, many breathers can only be used in a particular axle housing aperture where the axle housing is of a particular thickness or where the aperture itself is of a particular size. By requiring many types of breathers for many types of axle housings, a wide range of breathers has to be manufactured and stocked.

Lastly, many prior art breathers are constructed of metal, such as brass. Those skilled in the art appreciate that metal breathers can vibrate against the metal axle housings thus undesirably creating excess noise. The vibration can also fatigue the breathers themselves. Metal breathers also have to be threaded into the axle housing, which often times prevents the breather from being oriented in a particular direction.

In light of some of the disadvantages briefly discussed above with the prior art breathers, it would advantageous to have a breather that did not leak lubricant, that effectively vented the axle housing, that was less complex and more cost effective, that kept moisture from the outside from reaching the interior of the axle housing, that could be universally used in almost any axle housing aperture, that was constructed of a material that did not have the same concerns with vibration as the prior art and/or that could be oriented in any direction in the axle housing.

### SUMMARY OF THE INVENTION

The present invention is directed toward a device for communicating fluid into and out of a vehicle drive axle assembly housing. The device has an elbow, having a horizontal portion and a vertical portion, and a body portion. The vertical portion is located within the body portion. The elbow is at least partially blocked by a first baffle. The body portion is at least partially blocked by at least one baffle. The baffles reduce, or prevent, lubricant from escaping through the device from the drive axle housing.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of one embodiment of a drive axle assembly housing;

FIG. 2 is a perspective view of an embodiment of the present invention;

FIG. 3 is a cut-away side view of the invention depicted in FIG. 2;

FIG. 4 is a perspective view of a component of the present invention depicted in FIGS. 2-3;

FIG. 5 is a perspective view of a component of the present invention also depicted in FIGS. 2-3; and

FIG. 6 is a partial detail of a feature from FIG. 3.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

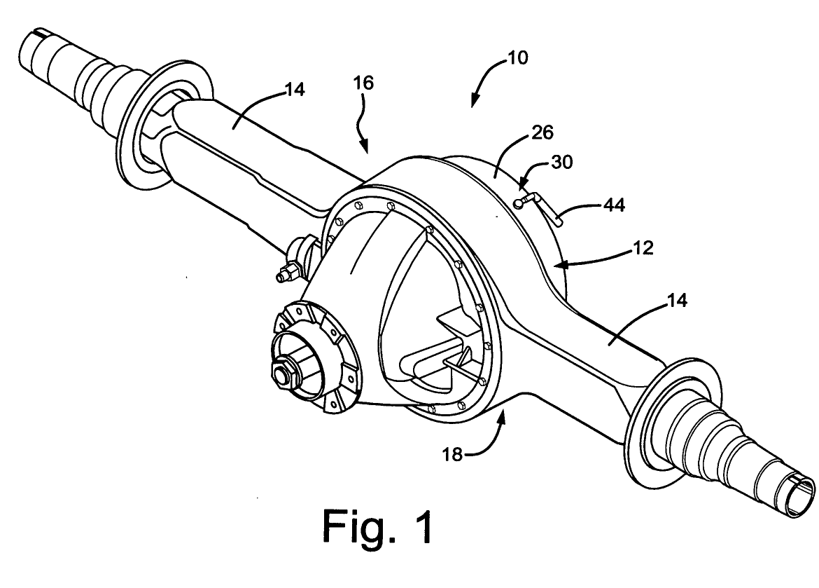

Referring now to FIG. 1, one embodiment of a drive axle assembly housing 10 is depicted. The drive axle assembly 10 has a bowl 12 for housing a differential (not shown). The assembly 10 also has two axle housings 14 connected to the bowl 12. The axle housings 14 each house a rotatable axle (not shown). The axles each connect to a wheel end (not shown) for providing drive to the wheel end.

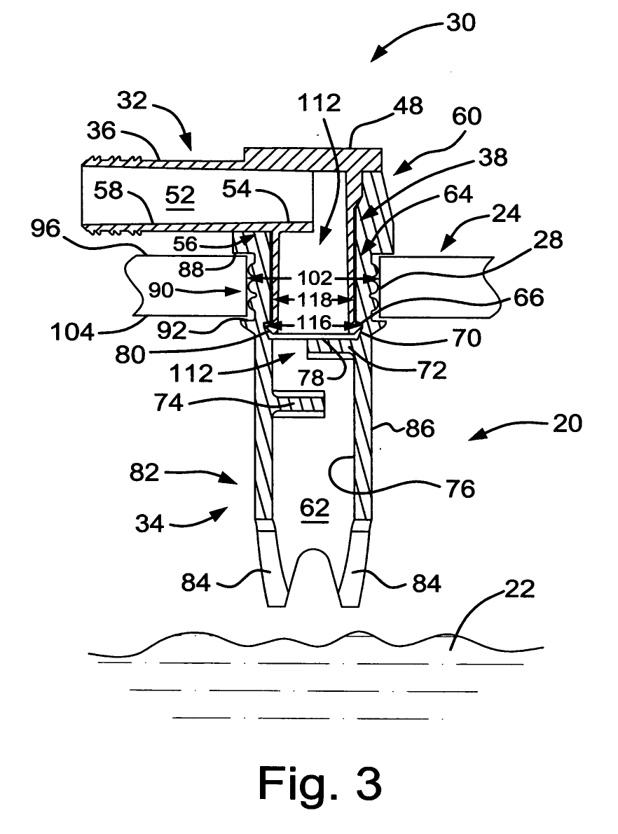

The drive axle assembly housing 10 has an upper portion 16, a lower portion 18 and a substantially hollow interior portion 20 (refer to FIG. 3 for the interior portion). The interior portion 20 has a pre-determined quantity of lubricant 22. The lubricant 22 lubricates and cools the various moving parts, including the differential, within the drive axle assembly housing 10. Those skilled in the art know that it is not required to fill the entire interior portion 22 with lubricant 22 to provide adequate lubrication and cooling to the various moving parts.

Preferably, the drive axle assembly housing 10 has an aperture 24 in the upper portion 16. While FIG. 1 depicts the aperture 24 being located in a cover 26 of the bowl 12, the present invention is not limited to locating the aperture 24 in this location. Instead, the aperture 24 can be located anywhere in the bowl 12 or the axle housings 14.

Regardless of where it is located, the aperture 24 extends to the interior portion 20, as seen in FIG. 3. The aperture 24 is preferably substantially circular and is defined by a circular wall 28 in the upper portion 16. While the circular wall 28 preferably has a substantially smooth bore, it must be appreciated that it is within the scope of the present invention for the wall 28 to be threaded.

FIG. 1 also depicts a device for venting the drive axle assembly housing 10, also known as a breather 30. The breather 30 is preferably located in the aperture 24 of the upper portion 16. It should be understood, however, that the breather 30 can be located anywhere in the drive axle assembly housing 10 that is above the fill level (not shown) of the lubricant 22.

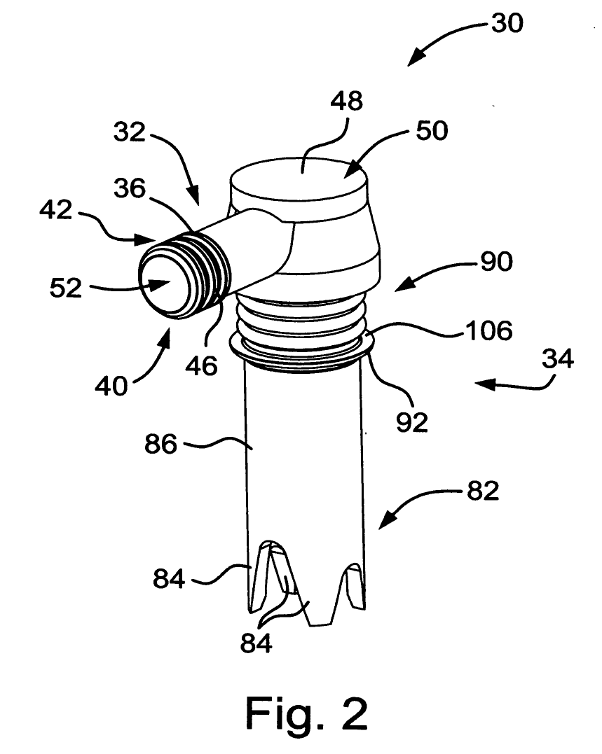

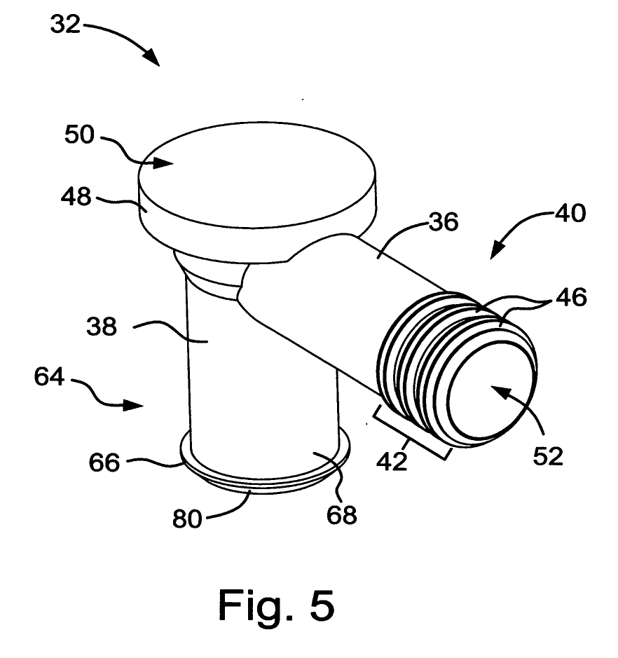

Turning now to FIGS. 2-5, a preferred embodiment of the breather 30 is depicted having an elbow 32 and a body portion 34. As best seen in FIGS. 3 and 5, the elbow 32 has a substantially horizontal portion 36 and a substantially vertical portion 38. An exterior end portion 40 of the horizontal portion 36 preferably has a frictional coupling 42 for connecting with a breather hose 44. The breather hose 44 can be seen in FIG. 1. In the preferred embodiment, the frictional coupling 42 is comprised of a plurality of rings 46 for engaging with an inside surface (not shown) of the breather hose 44. A mechanical fastener (not shown), such as a clamp member, can be located around an outside surface of the breather hose 44 adjacent where the inside surface is engaged with the rings 46 to ensure the hose 44 is adequately secured to the breather 30.

The horizontal portion 36 extends to a cap 48, or head, of breather 30. In the depicted embodiment of the invention, the cap 48, the substantially horizontal portion 36 and the substantially vertical portion 38 are integrally formed and one piece. The cap 48 preferably has a substantially planar upper surface 50. The planar upper surface 50 can be engaged with a hand or a tool to push the breather 30 into the aperture 24.

Preferably, the elbow 32 is constructed of a plastic or a reinforced resin. Either of these materials, or their equivalents, is preferred for the elbow 32 since at least the horizontal portion 36 and cap 48 will be located substantially outside of the drive axle assembly housing 10, thus exposing them to the driving environment under the drive axle assembly housing 10. Additionally, the elbow 32 needs to withstand the process for inserting the breather 30 into the aperture 24. It is also preferred that the material for the elbow 32 is resistant to both heat and cold since the drive axle assembly housing 10 can be exposed to temperatures ranging from −40° F. to 350° F.

As best seen in FIG. 3, the horizontal portion 36 and the vertical portion 38 define within them a first passageway 52. Preferably, the horizontal portion 36 and the vertical portion 38 are oriented substantially perpendicularly to one another and, thus, the first passageway 52 connecting them has a turn of approximately 90 degrees.

A first baffle 54 is located at a transition area 56 between the horizontal portion 36 and the vertical portion 38 within the first passageway 52. Preferably, the first baffle 54 is integrally formed with the elbow 32. It is also preferred that the first baffle 54 extend into the first passageway 52 as a substantially continuous extension of a lower wall 58 of the horizontal portion 36.

The body portion 34 of the breather 30 is best seen in FIGS. 2, 3 and 4. As can be seen in FIG. 3, an upper portion 60 of the body portion 34 accepts the substantially vertical portion 38 of the elbow 32 in a second passageway 62. As can be seen in FIG. 5, a lower portion 64 of the substantially vertical portion 38 of the elbow 32 has a substantially circumferential lip 66 on an exterior surface 68 of the lower portion 64. The lip 66 engages with a substantially circumferential cavity 70 in the second passageway 62 of the body portion 34, best seen in FIG. 3. The cavity 70 is located in the upper portion 60 of the body portion 34.

The second passageway 62 preferably has a second baffle 72 and a third baffle 74 that both extend substantially perpendicularly to an inner wall 76 of the second passageway 62. The second baffle 72 and the third baffle 74 are vertically offset from one another and they extend into the second passageway 62 substantially opposing one another.

As best seen in FIG. 3, it is preferred that the second baffle 72 is vertically offset from the first baffle 54 in the elbow 32. It is also preferred that the second baffle 72 extend into the second passageway 62 in a substantially opposite direction than the first baffle 54.

FIG. 3 also depicts the preferred embodiment wherein an upper surface 78 of the second baffle 72 abuts a terminal end 80 of the vertical portion 38 of the elbow 32 when the elbow 32 is installed in the body portion 34.

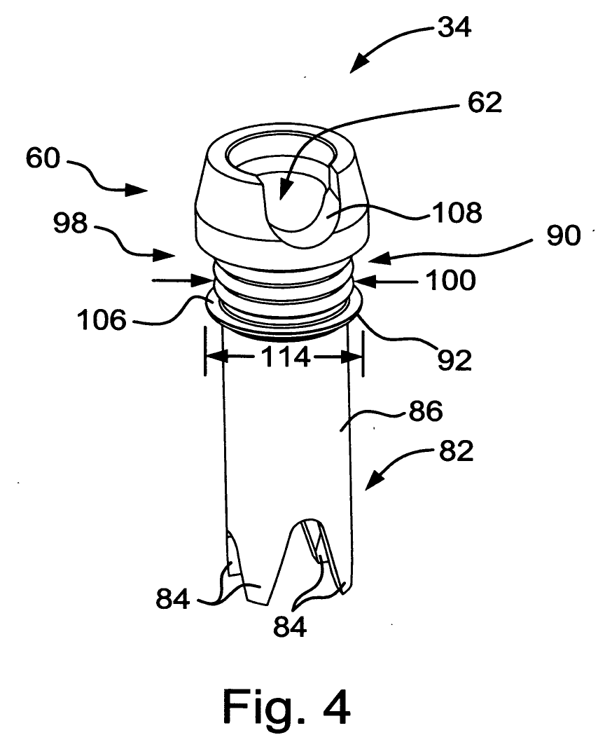

A bottom portion 82 of the body portion 34 is defined by a plurality of legs 84 where at least two of the legs 84 are unequal in length. The unequal length of the legs 84 can be seen in FIGS. 2 and 4. Legs 84 of unequal length break the formation of a static head of lubricant on the bottom portion 82. It can be appreciated that a static head of lubricant extending across the bottom portion 82 might block air from communicating through the breather 30.

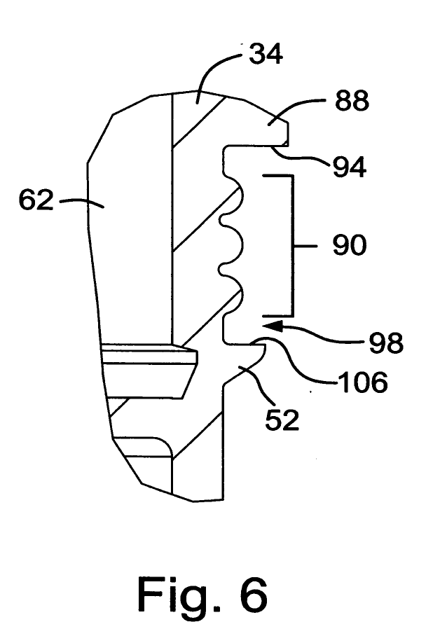

Looking now at FIGS. 2, 3, 4 and, in particular FIG. 6, an outside surface 86 of the body portion 34 can be seen. The outside surface 86 has an upper seal 88, at least two intermediate seals 90 and a lower seal 92. The upper seal 88 is located adjacent the transition area 56 of the horizontal portion 36 of the elbow 32 with the vertical portion 38 of the elbow 32. The upper seal 88 has an outwardly extending flange 94 that seals against an outer surface 96 of the drive axle assembly housing 10 adjacent the aperture 24. The upper seal 88 prevents the breather 30 from being inserted into the aperture 24 further than a desired predetermined amount.

The intermediate seals 90, which are preferably located within a reduced diameter portion 98 of the body portion 34, and which preferably number three, frictionally engage with the wall 28 that defines the aperture 24. Preferably, the outer diameter 100 of the intermediate seals 90 is slightly larger than the inner diameter 102 of the aperture 24 to assist the body portion 34 in frictionally engaging with the wall 28 that defines the aperture 24.

The lower seal 92 seals against an inner surface 104 of the interior portion 20 of the drive axle assembly housing 10. The lower seal 92 has an outwardly extending flange 106 that prevents the breather 30 from being unintentionally removed from the aperture 24.

The upper seal 88, the intermediate seals 90 and the lower seal 92 all prevent, or reduce, lubricant 22 from leaving the interior portion 20 or from exterior fluids from entering into the interior portion 20. The seals 88, 90, 92 are preferably arranged on the outside surface 96 of the body portion 34 from top to bottom in the following order: upper seal 88, intermediate seals 90, lower seal 92.

It can be appreciated based on the above-description that the breather 30 can be simply pushed into an aperture 24 in a drive axle assembly housing 10 without requiring the breather 30 to be threadably engaged with the aperture 24. It can also be appreciated that the breather 30, and its associated breather hose 44, can be inserted in the aperture 24 with the horizontal portion 36 pointed in any direction since the breather 30 is not dependent upon threads to secure it to the assembly housing 10.

Continuing now with a description of the body portion 34, it can be best seen in FIG. 4 that the upper portion 60 of the body portion 34 has a curvilinear depression 108 for receiving the horizontal portion 36 of the elbow 32.

Preferably, the body portion 34 is constructed of a rubber-like material. As the body portion 34, and in particular the above-described seals 88, 90, 92, will be in contact with the wall 28 that defines the aperture 24, the rubber-like material will assist in reducing vibration of the breather 30. The rubber-like material will also help the body portion 34 to resist movement within the aperture 24. It is preferred that the material for the body portion 34 is resistant to both heat and cold since the drive axle assembly housing 10 can be exposed to temperatures ranging from −40° F. to 350° F.

As best seen in FIG. 3, the vertically offset and substantially alternating opposing baffles 54, 72, 74 create two lubricant tumble chambers. Namely, a first lubricant tumble chamber 110 is located between the first baffle 54 and the second baffle 72 and a second lubricant tumble chamber 112 is located between the second baffle 72 and the third baffle 74.

It can be appreciated that during high speeds and/or vibration, lubricant 22 may be splashed such that it moves up into the body portion 34 and occasionally moves past the third baffle 74. This does not occur frequently since the third baffle, which is substantially planar, deflects the lubricant 22 downwardly into the interior portion 20. The vertically offset and alternately opposing second baffle 72 creates another stop that reduces or prevents lubricant 22 from moving beyond it. It is a discovery of the present invention that lubricant 22 that moves past the third baffle 74 splashes, or tumbles, in the second lubricant tumble chamber 112 and it substantially does not move past the second baffle 72. It can be appreciated that the second baffle 72, which is substantially planar, deflects the lubricant 22 downwardly toward the third baffle 74, thus creating a tumbling effect. The lubricant is free to drain out of the bottom of the chamber 112.

Any lubricant 22 that does move past the second lubricant tumble chamber 112 is caught by the first lubricant tumble chamber 110. It can be appreciated that the first baffle 54, which is substantially planar, deflects the lubricant downwardly toward the second baffle 72, thus creating a tumbling effect. The lubricant is free to drain out of the bottom of the chamber 110. Lubricant 22 in the first lubricant tumble chamber 110 merely splashes, or tumbles, around and it substantially does not flow out of the first lubricant tumble chamber 110 past the first baffle 54.

The design of the baffles 54, 72, 74, also functions to burst any bubbles that may form in the lubricant 22. Bubbles can form whenever the vehicle is moving, but are most likely to form when the vehicle is operating at high speeds and/or in bumpy conditions. Whenever a bubble reaches a baffle 54, 72, or 74, it typically bursts upon impact.

It can be appreciated that despite the fact that lubricant 22 is prevented from escaping from the axle assembly housing 10 through the breather 30, air is free to communicate to and from the axle assembly housing 10. Specifically, air is substantially free at all times to communicate around the first baffle 54, through the first lubricant tumble chamber 110, around the second baffle 72, through the second tumble chamber 112, around the third baffle 74, and past the legs 84 of the body portion 34 to the interior portion 20 of the axle assembly housing 10 and vice versa.

It can also be appreciated based on the above-described path air must follow to communicate into and out of the interior portion 20, that the lubricant 22 cannot do the same. Specifically, the lubricant 22 first must be splashed not just onto, but actually into, the second passageway 62. If the lubricant 22 is splashed into the second passageway 62, the length of the second passageway 62 from the legs 84 to the third baffle 74 may be too long for the lubricant 22 to traverse.

If the lubricant 22 does traverse the second passageway 62 to the third baffle 74, the planar nature of the baffle 74 will re-direct the lubricant 22 back toward the interior portion 20. Should lubricant avoid the third baffle 74, it cannot travel vertically through the second passageway 62 very far before coming in contact with the second baffle 72, as can be appreciated based on FIG. 3. In order to move beyond the second baffle 72, the lubricant 22 would have to make a turn of approximately 90 degrees.

The lubricant 22 would then have to travel upwardly so as to move past the second baffle 72. If the lubricant 22 continued to travel upwardly, so as to enter the first passageway 52, it would encounter the first baffle 54. The first baffle 54 would likely re-direct the lubricant 22 downwardly back to the interior portion 20. Since the first baffle 54 extends substantially orthogonally with respect to the body portion 34, for the lubricant 22 to move past the first baffle 54 it would have to make yet another turn of approximately 90 degrees.

Continuing to look at FIG. 3, it can be appreciated that to move beyond the first baffle 54, the lubricant 22 would have travel vertically and then make a third turn of approximately 90 degrees.

The body portion 34 is preferably located in the assembly housing 10 before the elbow 32 is located in the body portion 34. The body portion 34, being comprised of a flexible, rubber-like material, can be pushed into the aperture 24. This is despite the fact that the lower seal 92 has a larger outer diameter 114 (FIG. 4) than the inner diameter 102 of the aperture 24 (FIG. 3). The lower seal 92 merely flexes so that it, and part of the body portion 34, can be located in the interior portion 20. The vertical portion 38 of the elbow 32 is then inserted in the upper portion 60 of the body portion 34. The lip 66 located about the vertical portion 38 has a slightly larger diameter 116 (FIG. 3) than a diameter 118 (FIG. 3) of the vertical portion 38. The lip 66 is engaged with the cavity 70, thus securing the elbow 32 to the body portion 34. The lower seal 92, being located adjacent the cavity 70, is supported from behind by the lip 66 in the cavity 70. The support offered by the lip 66 to the lower seal 92 maintains the lip 66 in its original extended position to help secure the breather 30 within the aperture. The support offered by the lip 66 and the vertical portion 38 of the elbow 32 is in part form the less deformable plastic construction of the elbow 32.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A breather for a drive axle assembly housing, comprising:
an elbow comprising a substantially horizontal portion and a substantially vertical portion wherein said horizontal and vertical portions are connected by a first passage, said first passage being at least partially blocked by a first baffle integrally formed with said elbow; and
a body portion comprising a second passageway for receiving at least a portion of said vertical portion of said elbow therein and an exterior portion, said exterior portion having at least one seal, said second passage for communication with said first passage and said second passage having a second baffle and a third baffle wherein said first, second and third baffles are vertically offset from one another and said baffles extend into said first and second passages, respectively, substantially alternatingly opposing one another.

2. The breather of claim 1, wherein said elbow is a separate piece from said body portion.

3. The breather of claim 1, wherein said elbow is secured within said body portion by locating a substantially circumferential lip about a lower portion of said vertical portion of said elbow into a circumferential cavity in an upper portion of said body portion.

4. The breather of claim 1, wherein an end portion of said horizontal portion of said elbow has a frictional coupling that is opposite said vertical portion.

5. The breather of claim 1, wherein said elbow is constructed of plastic and said body portion is constructed of a rubber-like material.

6. The breather of claim 1, wherein said body portion comprises an upper seal, one or more intermediate seals and a lower seal on an outer portion thereof, said intermediate seals for frictionally engaging in a lubricant tight manner with a wall defining of an aperture in a drive axle assembly housing.

7. The breather of claim 1, wherein said body portion comprises a lower portion defining at least two legs of at least two lengths.

8. The breather of claim 1, wherein said first baffle, said second baffle and said third baffle create two tumble chambers for trapping lubricant among them, said baffles and said chambers permitting air to flow from said body portion to said elbow and vice versa.

9. The breather of claim 3, wherein said second baffle of said body portion abuts said circumferential lip on said elbow.

10. The breather of claim 1, wherein said second baffle and said third baffle are integrally formed with said body portion.

11. An axle breather, comprising:
an elbow comprising a substantially horizontal portion, a substantially vertical portion, a first internal passageway connecting said horizontal portion with said vertical portion and a horizontally oriented first baffle at least partially blocking said first internal passageway; and
a body portion having a second internal passageway having an upper portion for receiving said vertical portion of said elbow therein, said second internal passageway also having a middle portion and a lower portion, said middle portion having a second baffle and a third baffle both of which partially block said second internal passageway, said lower portion being defined by legs of at least two lengths, said body portion also having an exterior portion having a upper seal, at least two intermediate seals and a lower seal, each of which engage with a drive axle assembly housing.

12. The axle breather of claim 11, wherein said elbow is constructed of plastic and it is a separate piece from said body portion, which is constructed of a flexible material.

13. The axle breather of claim 11, wherein said elbow is secured within said body portion by locating a substantially circumferential lip about a lower portion of said vertical portion of said elbow into a circumferential cavity in said upper portion of said body portion.

14. The axle breather of claim 11, wherein said first baffle, said second baffle and said third baffle create two lubricant tumble chambers for trapping lubricant among them, said baffles and said chambers permitting air to flow from said body portion to said elbow and vice versa.

15. A device for venting a drive axle assembly housing, comprising:
an drive axle assembly housing having an upper portion, a lower portion and a hollow interior portion, said lower portion having a pre-determined quantity of lubricant in said hollow interior portion, said axle assembly housing also having an aperture in said upper portion, said aperture extending through to said hollow interior portion; and
a breather located in said aperture, said breather comprising an elbow and a body portion, said elbow comprising a substantially horizontal portion not located within said axle assembly housing and a substantially vertical portion located within said body portion, said body portion being frictionally secured to an inner wall of said aperture by at least two concentric structures on said body portion, said body portion extending into said interior portion of said drive axle assembly housing, said elbow forming a first baffle extending into an air passageway and said body portion having two additional baffles extending into said air passageway.

16. The device of claim 15, wherein said air passageway and said baffles permit air to flow into and out of said interior portion.

17. The device of claim 15, wherein said first baffle and said two additional baffles create two lubricant tumble chambers for trapping lubricant among them, said baffles being vertically offset from one another and substantially alternatingly opposing one another.

18. The device of claim 15, wherein said body portion comprises an upper seal, one or more intermediate seals and a lower seal on an outer portion thereof.

19. The device of claim 15, wherein said baffles define three turns of approximately 90 degrees each, said turns substantially blocking said lubricant from leaving said hollow interior portion.

20. The device of claim 15, wherein said lower seal, which is constructed of a flexible material, has a greater diameter than a diameter of said aperture requiring said lower seal to flex when said body portion is inserted in said aperture, said lower seal returning to an extended position in said interior portion when a lip about said substantially vertical portion of said elbow is located in a cavity in said body portion adjacent said lower seal.
